(19) United States
(12) Patent Application Publication
(10) Pub. No.: US 2024/0116461 A1
(43) Pub. Date: Apr. 11, 2024

(54) APPLIQUE AND SEALING ARRANGEMENT AND METHODS FOR PRODUCING SAME

(71) Applicant: Cooper-Standard Automotive (Deutschland) GmbH, Schelklingen (DE)

(72) Inventor: Tomasz Krefta, Lindau (DE)

(21) Appl. No.: 18/541,138

(22) Filed: Dec. 15, 2023

Related U.S. Application Data
(63) Continuation of application No. PCT/EP2022/064413, filed on May 27, 2022.

(30) Foreign Application Priority Data
Jun. 18, 2021 (EP) 21 180 361.4

(51) Int. Cl. B60R 13/04; B60J 10/20; B60J 10/36

(52) U.S. Cl. CPC B60R 13/04; B60J 10/20; B60J 10/36

(57) ABSTRACT

An applique arrangement for a vehicle surface, particularly an outer vehicle surface in a pillar region, comprises an applique having a panel portion that extends essentially along a first direction and a second direction transverse to the first direction and has a first inner portion, and a margin seal which extends along an edge of the applique in the second direction. The panel portion has a panel outer surface for forming a part of the vehicle surface. The first inner portion extends essentially in parallel to the margin seal and projects from the panel portion essentially in a third direction which is transverse to the first and second directions. The margin seal has a plurality of holding portions which are aligned along the direction of extension of the margin seal, and which are arranged at a distance from each other. The first inner portion of the applique has a plurality of receiving portions for receiving respective ones of the holding portions of the margin seal.

### CROSS-REFERENCE TO RELATED APPLICATIONS

This is a Continuation application of International patent application PCT/EP2022/064413, filed 27 May 2022, which claims the priority of European patent application EP21180361.4, filed 18 Jun. 2021, the entire contents of these earlier applications being incorporated herein by reference.

### FIELD

The present disclosure relates to an applique arrangement for a vehicle surface, particularly for an outer vehicle surface in a pillar region of the vehicle, comprising an applique having a panel portion that extends essentially along a first direction and a second direction transverse to the first direction, and a margin seal which extends along an edge of the applique in the second direction, wherein the panel portion has a panel outer surface for forming a part of the vehicle surface.

Further, the present disclosure relates to a sealing arrangement comprising a sealing strip and a margin seal for an applique arrangement. Also, the present disclosure relates to a method for producing a sealing arrangement and to a method for producing an applique arrangement.

### BACKGROUND

Vehicles, particularly automobiles, include a number of sealing arrangements for sealing in the area of interior access areas like doors, flaps, lids, etc. against the outside.

Particularly in vehicles having four doors, a so-called B-pillar is typically provided as a part of the vehicle body. The B-pillar is arranged between the respective front and rear doors.

In order to provide this area with an aesthetic appearance, it is known to provide so-called appliques between the windows of the front and the rear doors, in order to add styling or cover unsightly portions of the vehicle.

The windows of the front and rear doors are sealed against the outside by respective sealing arrangements. Further, in many cases, a sealing arrangement is provided between the front door and the rear door. This assists in sealing off the interior of the vehicle against the outside and also contributes to reducing noise in the inside of the vehicle (e.g. passenger compartment).

In some cases, the sealing arrangement that is provided between the front door and the rear door in the upper area of the doors (e.g., in the window area) is made part of the applique arrangement. Particularly, a margin seal is extruded separately and then adhered (e.g., by thermoplastic welding, glueing etc.) to an edge of the applique, so as to extend between the doors of the vehicle.

In some cases, the margin seal extends between an applique attached to the rear door and an applique attached to the front door of the vehicle.

U.S. Pat. No. 4,736,981 B provides an applique structure for the external B pillar areas of a four door vehicle. The vehicle structure is one wherein the pair of doors on each side are hingedly mounted at the forward edges and wherein the B pillar areas are defined by the upper door edges. The appliques are adhered to the B pillar area and form a double seal at the juncture therebetween. Additional seals are provided around the periphery of the appliques.

U.S. Pat. No. 6,416,113 B1 provides an applique for a pillar (e.g., B-pillar) of a vehicle, wherein the applique is a decorative member which is fastened to a vehicle surface (e.g., to a door frame structure adjacent a pillar) in order to add styling and/or to functionally cover unsightly portions of the vehicle. In certain embodiments, the applique includes a glass receiving channel defined in a portion thereof, as well as a hook-shaped retainer member extending from one wall of the channel. Moreover, in certain embodiments, the applique includes a polymer based retainer member attached to a metal portion of the applique for the purpose(s) of: 1) insulating the metal portion of the applique from sheet metal of the door frame structure, 2) covering an end/edge of the metal portion of the applique so as to prevent damage to any component which should rub or bump up against it, and/or 3) fastening the applique to the door frame structure or pillar using at least one fastener integrally molded with the polymer based retainer member.

In some cases, it is preferred to provide the applique with a coating, particularly for imparting the outer surface of the applique with a certain appearance.

### SUMMARY

It is an object to provide an improved applique arrangement, an improved sealing arrangement, as well as improved methods for producing same.

The above object is achieved by an applique arrangement, by a sealing arrangement, by a method for producing a sealing arrangement, and by a method for producing an applique arrangement.

In an exemplary embodiment of the disclosure, an applique arrangement for a vehicle surface, particularly for an outer vehicle surface in a pillar region of the vehicle, comprises an applique and a margin seal. The applique has a panel portion that extends essentially along a first direction and a second direction transverse to the first direction, and has an inner portion. The margin seal extends along an edge of the applique in the second direction. The panel portion, further, has a panel outer surface for forming a part of the vehicle surface. The first inner portion extends essentially in parallel to the margin seal and projects from the panel portion essentially in a third direction which is transverse to the first direction and to the second direction. The margin seal has a plurality of holding portions which are aligned along the direction of extension of the margin seal, and which are arranged at a distance from each other. The first inner portion of the applique has a plurality of receiving portions for receiving respective ones of the holding portions of the margin seal.

The holding portions of the margin seal are aligned along the direction of extension of the margin seal (preferably the second direction) like a number of protrusions that preferably protrude in a direction transverse to the second direction, preferably protrude in the first direction.

On the other hand, the receiving portions of the first inner portion of the applique are also aligned along the same direction of extension of the margin seal and have each an opening which faces to the margin seal, particularly in the first direction.

Therefore, the margin seal can be joined to the applique by inserting the holding portions into the receiving portions. Therefore, it is not necessary to provide an additional joining step for joining the margin seal to the applique, which in the prior art is done by thermoplastic welding, glueing or the like.

The concept of joining the margin seal and the applique by holding portions inserted into receiving portions of the applique has the additional advantage that the applique can be coated with any coating, even those coatings which would impair a traditional joint between the margin seal and the applique. Particularly, when the applique is joined by a metallic coating like a chrome coating, thermoplastic welding will be difficult or have a reduced lifespan.

In addition, the concept of introducing holding portions into the receiving portions can provide an extended joint lifespan.

Further, the holding portions and the receiving portions can be formed within a very small installation space, particularly in the third direction. Therefore, it is possible to provide the applique arrangement such that the applique does not protrude significantly in the third direction from respective window outer surfaces, so as to improve the overall aesthetic appearance.

The above object is further achieved by a sealing arrangement comprising a sealing strip and a margin seal for an applique arrangement of the present disclosure, wherein the sealing strip and the margin seal are joined by means of a mold portion. The sealing strip is particularly a sealing strip that extends in the second direction and is used as a sealing strip for receiving a side edge of a window of a vehicle door, particularly a rear door window.

The sealing strip is preferably an extruded sealing strip, made of TPE or EPDM or the like. The margin seal is also preferably an extruded part, made of the same or a different type of material. The margin seal is typically cut after extruding so as to provide the respective holding portions.

The sealing strip and the margin seal are joined by means of a mold portion.

In other words, the margin and the sealing strip are introduced into an injection molding form, and are joined to each other by means of a mold material injected into the tool.

Therefore, a method of producing a sealing arrangement according to the present disclosure comprises the steps of providing a sealing strip, providing a margin seal that has a plurality of holding portions which are aligned along the direction of extension of the margin seal, and which are arranged at a distance from each other, and molding an end portion of the margin seal to the sealing strip.

A method of producing an applique arrangement of the present disclosure comprises the steps of: providing a margin seal that has a plurality of holding portions which are aligned along the direction of extension of the margin seal, and which are arranged at a distance from each other, particularly a margin seal of a sealing arrangement as produced in accordance with the present disclosure, and providing an applique having a panel portion and a first inner portion, wherein the first inner portion has a plurality of receiving portions for receiving respective ones of the holding portions of the margin seal, and inserting the holding portions into the receiving portions so as to produce an applique arrangement.

The material of the applique is preferably a plastic material, which can be coated by another plastic material or by a metallic material. The applique can be a 1K-plastic material or can be a 2K- or 3K-compound plastic material.

Therefore, the above object may be achieved in full.

Preferably, the receiving portions are formed as through holes in the first inner portion.

This embodiment allows to produce the applique easily, for example by injection molding, wherein the injection molded plastic part is preferably coated thereafter.

In accordance with another embodiment, the holding portions are integral with a body portion of the margin seal.

Preferably, the margin seal is an extruded part, wherein the holding portions are formed by cutting out intermediate portions between the holding portions. The cutting step can be made by a knife, by a laser or by any other suitable tool.

In another preferred embodiment, the first inner portion has a radial part that extends from the panel portion in the third direction, and has an axial part that extends from the radial part.

The axial part preferably extends essentially in parallel to the applique, and extends preferably from the radial part in the first direction.

In this embodiment, an end portion of the panel portion and the first inner portion form a U-shape in cross section. Therefore, it is possible to introduce a part of a structure of the vehicle (a part of the door, for example) into the U-shaped cross section, so as to allow a stable attachment of the applique arrangement to the structure.

In a preferred embodiment, at least one of the holding portions has an elastically deformable holding lip which can be compressed in the third direction between the axial part of the first inner portion and a structure of the vehicle when fitted to the vehicle.

The holding lip is preferably formed at an end of the holding portions, which is introduced through the receiving portions and extends into the U-formed cross section. The holding lip can particularly be used to “draw” the applique against the structure of the vehicle in the third direction, so as to provide a stable attachment of the applique arrangement to the structure of the vehicle.

In another preferred embodiment, at least one of the holding portions has an elastically deformable locking lip which locks against the first inner portion when inserted into the respective receiving portion.

The locking lip is also preferably formed at the holding portion in a manner that the locking lip is guided through a receiving portion when the respective holding portion is inserted therein. The locking lip is preferably formed such that it is deformed in the third direction when the holding portion is introduced into the respective receiving portion, and elastically flaps back into a locking position. In the locking position, the locking flap engages an inner side of the first inner portion (particularly the radial part thereof) and prevents that the margin seal comes loose during operation of the vehicle.

Further, it is preferred if the margin seal has a body portion from which the holding portions project to one side in the first direction, and wherein the margin seal has a sealing lip portion which projects from the body portion to an opposite side in the first direction.

The sealing lip portion is the portion which extends from the body portion to the adjacent structure of the vehicle, particularly from the rear door to the front door or from the rear door applique to a front door applique, so as to seal off the interior of the vehicle when the doors are closed.

The material of the margin seal is preferably TPE or EPDM.

The material of the sealing strip mentioned above is also preferably TPE or EPDM.

The material of the applique is preferably a plastic material that is harder than the material of the margin seal.

In another preferred embodiment, the applique is coated with a coating, particularly a metallic coating like a chrome coating.

Further, it is overall preferred if the applique has a second inner portion which defines a sealing strip receptacle for receiving a sealing strip.

While the first inner portion is preferably provided in the area of a first end of the panel portion in the first direction, the second inner portion is preferably provided in the area of an opposite end of the panel portion in the first direction.

The second inner portion can be provided for receiving the sealing strip and/or for attaching the applique to a structure of the vehicle.

Therefore, it is preferred if the second inner portion comprises at least one attachment location for attaching the second inner portion to a structure of the vehicle.

In one embodiment, the second inner portion can be screwed or otherwise fastened to the structure of the vehicle.

The second inner portion, preferably, also provides a U-shaped cross section, together with a part of the panel portion. The U-shaped part forms the sealing strip receptacle. The U-shaped cross section is preferably open on the same side in the first direction as is the U-shaped first inner portion, which is formed by a radial part and an axial part, together with a part of the panel portion.

It will be understood that the afore-mentioned features and to be described hereinafter cannot only be used in the respectively given combination, but also in different combinations or independently, without leaving the scope of the present invention.

### BRIEF DESCRIPTION OF THE SEVERAL VIEWS OF THE DRAWING

Further features and advantages of the invention can be taken from the subsequent description of preferred embodiments with reference to the drawings. In the drawings:

FIG. 1 is a schematic side view of a vehicle having an applique arrangement;

FIG. 2 is cross-sectional view of an embodiment of an applique arrangement, corresponding to a cross-section along a line II-II in FIG. 1;

FIG. 3 is a side view of an embodiment of sealing arrangement comprising a margin seal and a sealing strip that are molded together, for the applique arrangement of FIG. 2;

FIG. 4 is an enlarged side view of the margin seal of FIG. 3;

FIG. 5 is a side view of an applique for the applique arrangement of FIG. 2; and

FIG. 6 is cross-sectional view of a prior art applique arrangement, corresponding to a cross-section along a line II-II in FIG. 1.

### EMBODIMENTS

In the following, embodiments of the present disclosure are described in detail.

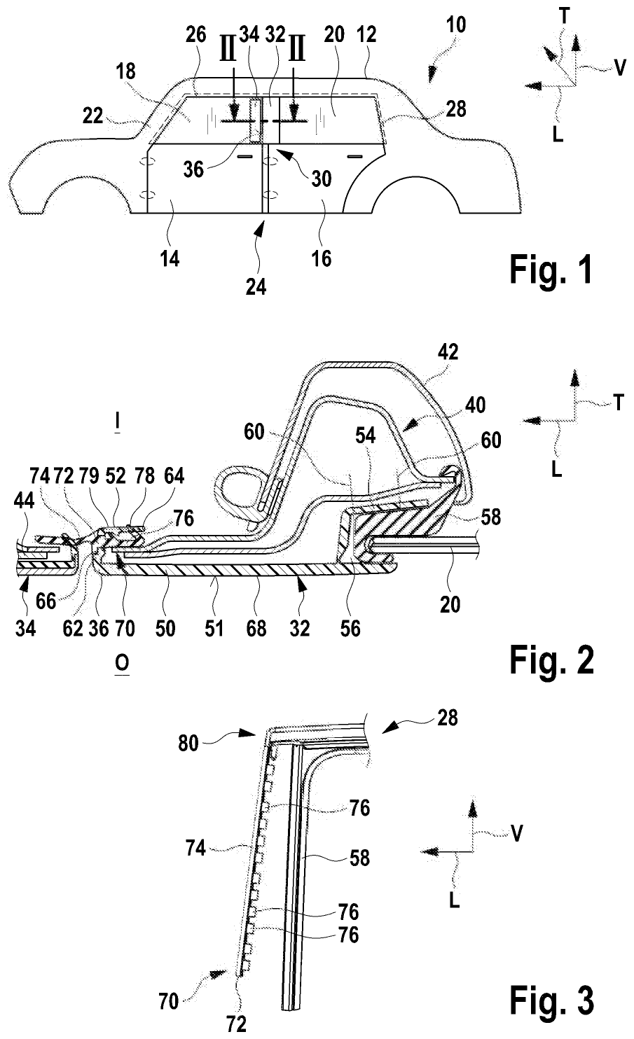

An automobile, like a passenger car vehicle, is schematically shown in FIG. 1 and generally denoted by 10. The vehicle 10 has a body 12, to which are hingedly connected a front door 14 and a rear door 16.

The front door 14 has a front door window 18. The rear door 16 has a rear door window 20.

The front door 14 and the rear door 16 are each preferably hingedly mounted at the respective forward edges. The body 12 includes an A-pillar region 22 in the area of the forward edge of the front door 14, and a B-pillar region 24 which is arranged essentially between the front door 14 and the rear door 16. Preferably, the rear door 16 is hingedly mounted to the B-pillar region 24.

The front door 14 has a front door window sealing arrangement 26 for the front door window 18. The rear door 16 has a rear door window sealing arrangement 28 for the rear door window 20.

The body 12 defines a first direction L, which is preferably a longitudinal direction of the vehicle 10. Further, the body 12 defines a second direction V which is preferably a vertical direction of the vehicle 10. In addition, the body 12 defines a third direction T, which is preferably a transverse direction of the vehicle. The three directions are also used to describe an applique arrangement.

The vehicle 10 includes an applique arrangement 30 which is provided in the B-pillar region 24 between the front door window 18 and the rear door window 20.

The applique arrangement 30 includes a first applique which is assigned to the rear door 16, and preferably also a second applique 34 which is assigned to the front door 14. The second applique 34 is an optional element. Each of the appliques 32, 34 extend essentially in a flat shape along the first direction L and the second direction V and provide an aesthetic appearance in the B-pillar region.

The first applique 32 has an applique edge 36 which extends along the second direction V.

FIG. 2 shows a cross section of the applique arrangement 30 along a line II-II in FIG. 1, in accordance with an embodiment of the present disclosure.

The rear door 16 has a rear door B-pillar structure 40 to which a B-pillar inner lining 42 is attached which faces into an interior I of the vehicle 10, i.e. to a passenger compartment. A front door rear edge structure is shown schematically at 44. It can be seen, that the optional second applique 34 is attached to the front door rear edge structure 44.

The front door 14 and the rear door 16 are provided for separating the interior I of the vehicle from the outside O thereof, or allowing access thereto when opened.

The first applique 32 has a panel portion 50 which essentially extends along the first direction L and the second direction V. The panel portion 50 has a panel outer surface 51, which is visible from the outside O of the vehicle.

Further, the first applique 32 has a first inner portion 52 and a second inner portion 54.

The first inner portion 52 is joined to the panel portion 50 in the area of a front portion of the panel portion 50 in the first direction L. On the other hand, the second inner portion 54 is joined to the panel portion 50 in an area of a rear portion of the panel portion 50 in the first direction L.

The second inner portion 54 forms a sealing strip receptacle 56 which has a U-shaped cross section along a plane defined by the first direction L and the third direction T.

A sealing strip 58 is introduced into the sealing strip receptacle 56. The sealing strip 58 guides a front edge of the rear door window 20 in this embodiment. The sealing strip 58 is shown schematically. Typically, the sealing strip 58 includes a number of sealing lips for engaging the window 20 and/or a number of locking portions for engaging the rear door B-pillar structure 40, as is shown in FIG. 6

The second inner portion 54 comprises at least one attachment location 60 for attaching the second inner portion 54 to the structure 40.

The first inner portion 52 includes a radial part 62 which is joined to the first applique 32 at the applique edge 36 thereof. The radial part 62 projects from the panel portion 50 essentially in the third direction T, and extends along the second direction V.

The first inner portion 52, further, includes an axial part 64 which is joined to an inner portion of the radial part 62. The axial part 64 projects from the radial part 62 in the first direction L, and extends in the second direction V. The front part of the panel portion 50, the radial part 62 and the axial part 64 form a U-shaped cross section along a plane defined by the first direction L and the third direction T.

The radial part 62 has a number of margin seal receiving portions 66, one of which being shown in FIG. 2. The margin seal receiving portions 66 are formed as through holes in the radial part 62. Each of the trough holes extends in the first direction L. The receiving portions 66 are aligned along the second direction V, as can be seen in FIG. 5, and are arranged at a distance from each other in the second direction V.

The first applique 32 is preferably provided with an outer coating 68, which is preferably a metallic coating like a chrome coating.

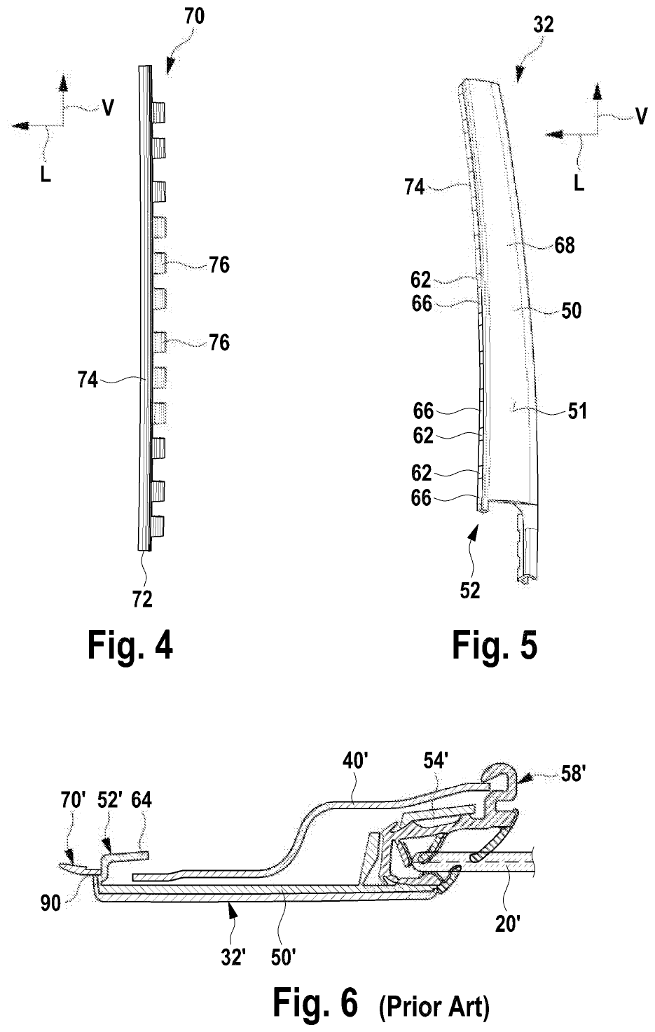

The applique arrangement 30 includes a margin seal 70. The margin seal 70 is shown in detail in FIGS. 3 and 4.

The margin seal 70 includes a body portion 72 that extends essentially along the second direction V. Further, the margin seal 70 includes a sealing lip portion 74. The sealing lip portion 74 projects from the body portion 72 in the first direction L, particularly in a forward direction if the applique arrangement 30 is fitted to the vehicle structure 44.

As can be seen in FIG. 2, the sealing lip portion 74 is arranged so as to bridge the distance between the first applique 32 and the front door, particularly the second applique 34 of the front door. The sealing lip portion 74 extends along the second direction V.

Further, the margin seal 70 includes a number of holding portions 76. Each of the holding portions 76 protrudes from the body portion 72 in the first direction L, particularly to a side in the first direction which is opposite to the side into which the sealing lip portion 74 projects.

The holding portions 76 are each assigned to a respective receiving portion 66, are aligned along the second direction V and are arranged at a distance from each other.

Further, at least one of the holding portions 76 of the margin seal 70 includes a holding lip 78. The holding lip 78 is provided in an end area of the respective holding portion 76.

As can be seen in FIG. 2, the holding portions 76 of the margin seal 70 are introduced into the respective receiving portions 66 such that the holding portions 76 project into the U-shaped cross section formed by the panel portion 50 and the first inner portion 52.

Particularly, the holding portions 76 are introduced into the U-shaped cross section such that the holding portions 76 are arranged between a portion of the rear door B-pillar structure 40, which extends into the U-shaped section, and the axial part 64 of the first inner portion 52.

The holding lips 78 are arranged such that they are elastically deflected between the structure 40 and the axial part 64 in the third direction T, and thereby convey a force onto the panel portion 50 which is directed to the interior I of the vehicle 10.

In addition, at least one of the holding portions 76 of the margin seal 70 includes a locking lip 79 which is provided between the body portion 72 and the holding lip 78.

When inserted into the receiving portion 66, the locking lip 79 of the holding portion 76 engages behind a portion of the radial part 62 and/or of the axial part 64, so as to lockingly engage the first inner portion 52. The locking lip 79 serves to secure the margin seal 70 to the first applique 32, particularly against forces in the first direction L.

As can be seen in FIG. 4, the margin seal 70 can be an extruded element, from which intermediate portions between holding portions 76 are cut out.

The first applique 32 is typically an injection molded element having the number of margin seal receiving portions 66 in the radial part 62 of the first inner portion 52 thereof, and the panel outer surface 51 which forms the visible part of the panel portion 50.

The margin seal 70 and the sealing strip 58 are joined together by means of a mold portion 80, as can be seen in FIG. 3.

In fact, the mold portion 80 may be provided for joining the margin seal 70, the sealing strip 58 and also an upper portion of the rear door window sealing arrangement 28 together.

Therefore, the applique arrangement 30 is preferably produced by first joining the margin seal 70 and the sealing strip 58 via the mold portion 80. In a second step, the first applique 32 is formed by injection molding and optionally coated. In a third step, the first applique 32 is attached to the margin seal 70, by introducing the holding portions 76 into the receiving portions 66. in some examples, the sealing strip is inserted in the sealing strip receptacle 56.

Finally, the so-produced applique arrangement 30 can be mounted to the body 12 of the vehicle, particularly to the rear door B-pillar structure 40.

FIG. 6 shows a prior art applique arrangement, having a first applique 32′ which comprises a panel portion 50′ and a first inner portion 52′. The first inner portion 52′ has an axial part 64 as in the above embodiments.

A margin seal 70′ is attached to an edge of the first applique 32′ by means of a thermoplastic weld 90.

In FIG. 6, a sealing strip 58′ is shown which may replace the sealing strip 58 shown schematically in FIG. 2.

### REFERENCE NUMERALS

10 automobile/vehicle
12 body
14 front door
16 rear door
18 front door window
20 rear door window
22 A-pillar region
24 B-pillar region
26 front door window sealing arrangement
28 rear door window sealing arrangement
30 applique arrangement
32 first applique
34 second applique
36 applique edge
40 rear door B-pillar structure
42 B-pillar inner lining
44 front door rear edge structure
50 panel portion (32)
51 panel outer surface (visible)
52 first (front) inner portion (32)
54 second (rear) inner portion (32)
56 sealing strip receptacle
58 sealing strip
60 attachment location
62 radial part (52)
64 axial part (52)
66 margin seal receiving portions
68 coating
70 margin seal
72 body portion (70)
74 sealing lip portion (70)
76 holding portions (70) for 66
78 holding lip (76)
79 locking lip (76)
80 mould portion
90 thermoplastic weld
L longitudinal (first) direction
V vertical (second) direction
T transversal (third) direction
I inside
O outside

1. An applique arrangement for a vehicle surface, comprising:
an applique having a panel portion that extends essentially along a first direction and a second direction transverse to the first direction, and having a first inner portion; and
a margin seal which extends along an edge of the applique in the second direction,
wherein the panel portion has a panel outer surface for forming a part of the vehicle surface,
wherein the first inner portion extends essentially in parallel to the margin seal and projects from the panel portion essentially in a third direction which is transverse to the first direction and to the second direction,
wherein the margin seal has a plurality of holding portions which are aligned along the direction of extension of the margin seal, and which are arranged at a distance from each other,
wherein the first inner portion of the applique has a plurality of receiving portions for receiving respective ones of the holding portions of the margin seal,
wherein the material of the margin seal is TPE or EPDM, and
wherein the material of the applique is a plastic material that is harder than the material of the margin seal.

2. The applique arrangement of claim 1, wherein the receiving portions are formed as through holes in the first inner portion.

3. The applique arrangement of claim 1, wherein the holding portions are integral with a body portion of the margin seal.

4. The applique arrangement of claim 1, wherein the first inner portion has a radial part that extends from the panel portion in the third direction, and has an axial part that extends from the radial part.

5. The applique arrangement of claim 4, wherein at least one of the holding portions has an elastically deformable holding lip which can be compressed between the axial part of the first inner portion and a structure of the vehicle when fitted to the vehicle.

6. The applique arrangement of claim 4, wherein at least one of the holding portions has an elastically deformable locking lip which locks against the first inner portion when inserted into the respective receiving portion.

7. The applique arrangement of claim 1, wherein the margin seal has a body portion from which the holding portions project to one side in the first direction, and wherein the margin seal has a sealing lip portion which projects from the body portion to an opposite side in the first direction.

8. The applique arrangement claim 1, wherein the applique is coated with a coating.

9. The applique arrangement of claim 1, wherein the applique has a second inner portion which defines a sealing strip receptacle for receiving a sealing strip.

10. The applique arrangement of claim 9, wherein the second inner portion comprises at least one attachment location for attaching the second inner portion to a structure of the vehicle.

11. An applique arrangement for a vehicle surface, comprising:
an applique having a panel portion that extends essentially along a first direction and a second direction transverse to the first direction, and having a first inner portion,
a margin seal which extends along an edge of the applique in the second direction,
wherein the panel portion has a panel outer surface for forming a part of the vehicle surface,
wherein the first inner portion extends essentially in parallel to the margin seal and projects from the panel portion essentially in a third direction which is transverse to the first direction and to the second direction,
wherein the margin seal has a plurality of holding portions which are aligned along the direction of extension of the margin seal, and which are arranged at a distance from each other, and
wherein the first inner portion of the applique has a plurality of receiving portions for receiving respective ones of the holding portions of the margin seal.

12. The applique arrangement of claim 11, wherein the receiving portions are formed as through holes in the first inner portion.

13. The applique arrangement of claim 11, wherein the holding portions are integral with a body portion of the margin seal.

14. The applique arrangement of claim 11, wherein the first inner portion has a radial part that extends from the panel portion in the third direction, and has an axial part that extends from the radial part.

15. The applique arrangement of claim 14, wherein at least one of the holding portions has an elastically deformable holding lip which can be compressed between the axial part of the first inner portion and a structure of the vehicle when fitted to the vehicle.

16. The applique arrangement of claim 14, wherein at least one of the holding portions has an elastically deformable locking lip which locks against the first inner portion when inserted into the respective receiving portion.

17. The applique arrangement of claim 11, wherein the margin seal has a body portion from which the holding portions project to one side in the first direction, and wherein the margin seal has a sealing lip portion which projects from the body portion to an opposite side in the first direction.

18. The applique arrangement of claim 11, wherein the applique is coated with a coating.

19. The applique arrangement of claim 11, wherein the applique has a second inner portion which defines a sealing strip receptacle for receiving a sealing strip.

20. A method of producing an applique arrangement, comprising the steps of:
providing a margin seal that has a plurality of holding portions which are aligned along the direction of extension of the margin seal, and which are arranged at a distance from each other, and
providing an applique having a panel portion and a first inner portion, wherein the first inner portion has a plurality of receiving portions for receiving respective ones of the holding portions of the margin seal, and
inserting the holding portions into the receiving portions so as to produce the applique arrangement.
